(19) United States
(12) Patent Application Publication
(10) Pub. No.: US 2016/0060957 A1
(43) Pub. Date: Mar. 3, 2016

(54) EASY STEP ASSISTIVE DEVICE

(71) Applicant: FUNMI ONOBRAKPEYA, YORK, PA (US)

(72) Inventor: FUNMI ONOBRAKPEYA, YORK, PA (US)

(21) Appl. No.: 14/805,676

(22) Filed: Jul. 22, 2015

Related U.S. Application Data
(63) Continuation-in-part of application No. 13/089,670, filed on Apr. 19, 2011, now abandoned.

(51) Int. Cl. E06C 1/393; E06C 1/14; E06C 7/18

(52) U.S. Cl. CPC E06C 1/393; E06C 7/183; E06C 1/14

(57) ABSTRACT

An exemplary embodiment is an assistive device for enabling individuals with limited mobility to step up to a generally horizontal patient support apparatus having: a pair of foldable frames each having a generally U-shaped vertical side frame. Each of the frames has a plurality of horizontal support members and is coupled to one or more horizontal support bars that are located at a rear of the device. A plurality of foldable steps is coupled to the frames. A method of a patient/user using the device described above includes the acts of: unfolding a folded device (if folded); placing the device with a rear portion facing and against an examination table or bed. Having the patient/user grip a pair of grips and placing a first foot on a lower step. The patient then places a second foot on an upper step with the first foot remaining on the lower step while maintaining his/her hands on the grips. The patient then places the second foot on the second step, thus having both feet on the upper step and in a standing position while gripping the grips. The patient then turns around on the upper step to face away from the examination table or bed while still gripping the grips and moving to a sitting position on the examination table.

### CROSS REFERENCE

This application is a Continuation-in-Part application of U.S. Non-Provisional application Ser. No. 13/089,670 ('670) filed on Apr. 19, 2011 and is hereby incorporated in full herein by reference. This application is also related to provisional application Ser. No. 61/382,961 filed on Sep. 15, 2010 entitled Easy Step Examination Table Device” and is hereby incorporated in full herein by reference.

### FIELD OF TECHNOLOGY

The field of technology is an improved assistive device to enable individuals with limited mobility to step up to an examination table in a physician's office during physical examinations.

### BACKGROUND

There is a need for an assistive device that enables an individual with limited mobility to step up to an examination table in a physician's office during a physical examination. As a physician, the Applicant has observed the difficulties that elderly and patients with limited mobility experience during attempts to transfer them to a medical examination table during visits. The Applicant has observed the need for a product that facilitates the transfer of these patients by the physicians or medical staff more conveniently and expediently to the table for medical examination.

Such a device needs to be a stepping device with handles for support and short, wide steps which allow patients to climb up to the examination table with ease and turn around to sit on the table without an increased risk of falling. The design of older examination tables currently in use does not address this problem and the newer examination tables being manufactured are very expensive costing 5-10 times the price of the older tables now in use. Therefore there is a need for a cost effective solution to the current problem that is expected to increase in magnitude over time since the population is aging.

The primary need for such a device is in a physician's office with a large geriatric patient population such as internists, geriatricians, rheumatologists and orthopedic surgeons who see a large population of the infirm and younger patients with difficult mobility. Ultimately all physicians and medical practitioners will need such a device since there are aging patients in most of the medical specialties. The secondary need for such a device is in the general population of the elderly, and those with limited mobility who will benefit day to day use of the product at home. These needs would be met by a standalone device that satisfies the needs of the patients and the physicians. A tertiary need for the device is one that it is incorporated within an examination table made by manufacturers of examination tables, where there exists a need for such a device in the design of future medical examination tables.

In addition, such a device would satisfy the need for: Increased patient satisfaction and improvement in overall patient experience; Increased efficiency of office staff, with less time spent transferring patients to examination tables therefore improving office work flow; and Decreased time spent by physicians in patient transfers on and off the examination table allowing more time to be spent during the visit in discussions with the patient.

The most commonly used examination table known to the Applicant that provides a step function to an examination table surface is described in U.S. Pat. No. 6,550,084 ('084) by Siepman et al. and assigned to The Brewer Company entitled “Medical Examination Table Step” and is sold by Brewer as its Brewer Basic Exam Table. FIG. 1 illustrates the '084 table with the table step inside the table structure. FIG. 2 illustrates the '084 table with the table step outside the table structure. FIG. 3 illustrates the details of the structure of the '084 table step. FIG. 4 illustrates details of the rolling process of the '084 table step.

Another commonly used examination table with a drawer type step is described in U.S. Pat. No. 7,386,899 ('899) by Smith and assigned to the Midmark Corporation. The '899 device is sold by Midmark as its Midmark 604 and Ritter 204 examination tables. FIG. 5 illustrates the '899 table with the table step in the open position. FIG. 6 illustrates details of the '899 table step.

Many conventional medical examination tables have a step that is movable from a stored position to a position for use by the patient as an aid to mount the examination table. Typically, such steps incorporate a hinge mechanism, whereby the step rotates from a stored position to a position for mounting, or a cantilevered track configuration whereby the step extends into a useful position in a drawer-like manner.

Retractable steps are desirable on medical examination tables because they provide an aid to the patient when mounting the examination table. Further, the step can be stored in the table when not in use, thus permitting better access to the patient, and removing obstacles from what are typically cramped examination rooms.

By means of example, Kales (U.S. Pat. No. 487,625) ('625) describes a cantilevered sliding step with hinged support braces and a pull-out handle. In another example, Daggett (U.S. Pat. No. 488,649) ('649) describes a retractable cantilevered step. Lentz's U.S. Pat. No. 542,060 ('060) describes a hinged step coupled to a leg rest of the examination table.

When the leg rest is in a vertical position, the step can be placed in a horizontal position, enabling the patient to mount the examination table. When the leg rests are placed in a horizontal position, the step can be rotated to lie in line with the leg rest by means of the hinge mechanism.

In another example, Grant's U.S. Pat. No. 3,016,275 describes a cantilevered pullout step that is guided by tracks. The step is retracted by pulling on a lower edge of a front side of the step. A step is again described by Douglass' U.S. Pat. No. 3,334,951 ('951). Douglass uses a cantilevered step that is slideably mounted on guide tracks by means of a guide rail. An upper face of the step has a tread to ensure adequate traction. Kharchik's U.S. Pat. No. 6,209,463 ('463) describes a cantilevered retractable footstool including a runner with a locking mechanism that selectively limits the extension of the step in relation to the table.

One disadvantage common to the much of the prior art is the use of a cantilevered step. The use of such a design may compromise patient safety. An overly large step tends to act as a lever and the typical patient would then topple the examination table when using the step. To avoid this, some of the prior art uses a rather narrow cantilevered step. This creates another disadvantage, as the step then is too small for patients to safely mount the examination table. While preventing the table from toppling, such small steps may cause the patient to fall!

In an attempt to alleviate such misfortune, the aforementioned Kales ('625) device incorporates support legs that hinge from the cantilevered step. However, the mechanism that automatically deploys the hinged braces is cumbersome and unreliable. Consisting of narrow members and a strap guided by a groove, the Kales mechanism is relatively delicate, susceptible to jamming or breaking and the braces may be inadvertently dislodged by the patient or care provider during use, resulting in a dangerous situation.

Another disadvantage of much of the prior art is the use of guide tracks and guide rails to retract and extend the step by sliding. This arrangement is susceptible to jamming and sticking, as a relatively large frictional surface on the guide rail and guide track are continually in contact. Such designs are largely not self-aligning, which further exacerbates the problem of jamming and sticking. Another disadvantage of much of the prior art is a lack of means for preventing over extension or excessive retraction of the step. A major disadvantage of much of the prior art is that the steps have a small elevated supporting surface, making it difficult for patients to maneuver and turn on the step while trying to mount the table.

Accordingly, the retractable step of the Siepman/Brewer ('084) device that is self-supporting, thereby eliminating the dangerous toppling condition is a step forward. The Siepman/Brewer '084 device has a relatively large step in order to improve the ease of use and patient maneuverability when used. The retractable step of the Siepman/Brewer '084 slides easily from the stored position to the extended position and returns as easily, without sticking or jamming avoids over extension or excess retraction by a self-assuring means.

However, Siepman-Brewer '084 device does not satisfy the need for an appropriate stepping device that meets the needs of individuals who are elderly or have limited mobility and safely provides support, in the applicant's experience with such individuals.

### SUMMARY

There are two principal embodiments of the invention described that satisfy the needs cited in the Background of the Invention. The first embodiment is a portable device that is used in conjunction with an existing medical examination table. Another embodiment is a device attached to a Siepman-Brewer ('084) device, a Smith-Midmark ('899) device, or a similar examination table with a pull out step system.

The stand-alone device is similar to a walker or rollator in appearance, but serves a uniquely different function. A rollator or walker assists a patient with walking therapy or assists the patient overcome stability and or energy functions while walking. The first embodiment enables an individual with limited mobility to step up to and easily get access to an examination table in a physician's office during a physical examination or a hospital bed in a hospital or home.

A first embodiment relates generally to an ambulatory support having one or more rigid steps to allow the user to step up safely and easily to an examination table or other horizontal or mostly horizontal support devices. Further, the side frame members of the device can be folded inwardly in order to conserve storage space.

This first embodiment is more fully described as an assistive device for enabling individuals with limited mobility to step up to a generally horizontal patient support apparatus having: a pair of foldable frames each having a generally U-shaped vertical side frame. Each of the frames has a plurality of horizontal support members; the frames are coupled to one or more horizontal support members that are located at a rear of the device; and a plurality of vertically foldable steps coupled to the frames.

A method of using the device is described as: A method of a patient/user using the device described above including the acts of: unfolding a folded device (if folded); placing the device with a rear portion facing and against an examination table or bed; gripping a pair of grips and placing a first foot on a lower step; placing a second foot on an upper step with the first foot remaining on the lower step maintaining his/her hands on the grips; placing the second foot on the second step, thus having both feet on the upper step and in a standing position while gripping the grips; turning around on the upper step to face away from the examination table or bed while still gripping the grips; and moving to a sitting position on the examination table.

### BRIEF DESCRIPTION OF THE DRAWINGS

These and other features, aspects, and advantages of the present embodiment(s) of the invention will become better understood with regard to the following description, appended claims, and accompanying drawings where:

FIG. 1 illustrates the '084 table with the table step inside the table structure;

FIG. 2 illustrates the '084 table with the table step outside the table structure;

FIG. 3 illustrates the details of the structure of the '084 table step;

FIG. 4 illustrates details of the rolling process of the '084 table step;

FIG. 5 illustrates the '899 table with the table step in the open position;

FIG. 6 illustrates details of the '899 table step:

FIG. 7 illustrates a left side elevation of a basic embodiment of the assistive device in an open position in accordance with the present invention;

FIG. 8 illustrates a right side elevation of a basic embodiment of the assistive device in an open position in accordance with the present invention;

FIG. 9 illustrates a front view of the assistive device shown in Figure FIGS. 7 and 8 and in an open position;

FIG. 10 illustrates an isometric front view of the assistive device;

FIG. 11 illustrates an isometric rear view of the assistive device;

FIG. 12 illustrates a detailed portion of the left rear leg-illustrating the inwardly folding mechanism;

FIG. 13 illustrates a closed position of the assistive device with the steps in an upwardly folded position and the sides folded inwardly;

FIG. 14 illustrates a user facing the device that has been placed in front of an examination table;

FIG. 15 illustrates the patient/user with his/her hands gripping the handles and with a first foot on a lower step of the device.

FIG. 16 illustrates the patient/user with his/her second foot on the upper step of the device and the first foot remaining on the lower step of the device while maintaining his/her hands on the grips on the device;

FIG. 17 illustrates the patient/user with both feet on the upper step and is in a standing position on the device while gripping the grips;

FIG. 18 illustrates the patient/user having turned around on the upper step to face away from the examination table while still gripping the grips on the device; and

FIG. 19 illustrates the patient/user in a sitting position on the examination table.

### DETAILED DESCRIPTION

There are two principal embodiments of the invention are described that satisfy the needs cited in the Background section. A first embodiment is a portable device that is used in conjunction with an existing medical examination table. The second embodiment is a device attached to a Siepman-Brewer ('084) device, a Smith-Midmark ('899) device, or a similar examination table with a pull out step system.

The stand-alone device is similar to a walker or rollator in appearance, but serves a uniquely different function. A rollator or walker assists a patient with walking therapy or assists the patient to overcome stability and or energy functions while walking. The first embodiment enables an individual with limited mobility to step up to and easily get access to an examination table in a physician's office during a physical examination; in a hospital bed in a hospital or at home; or another horizontal support device.

The first embodiment relates generally to an ambulatory support having one or more rigid steps to allow the user to step up to an examination table or other horizontal or mostly horizontal support devices. Further, the side frame members of the device can be folded inwardly in order to conserve storage space. The second embodiment is the combination of an assistive device and the ability to store the assistive device into the examination table when the assistive device is not needed.

### First Embodiment

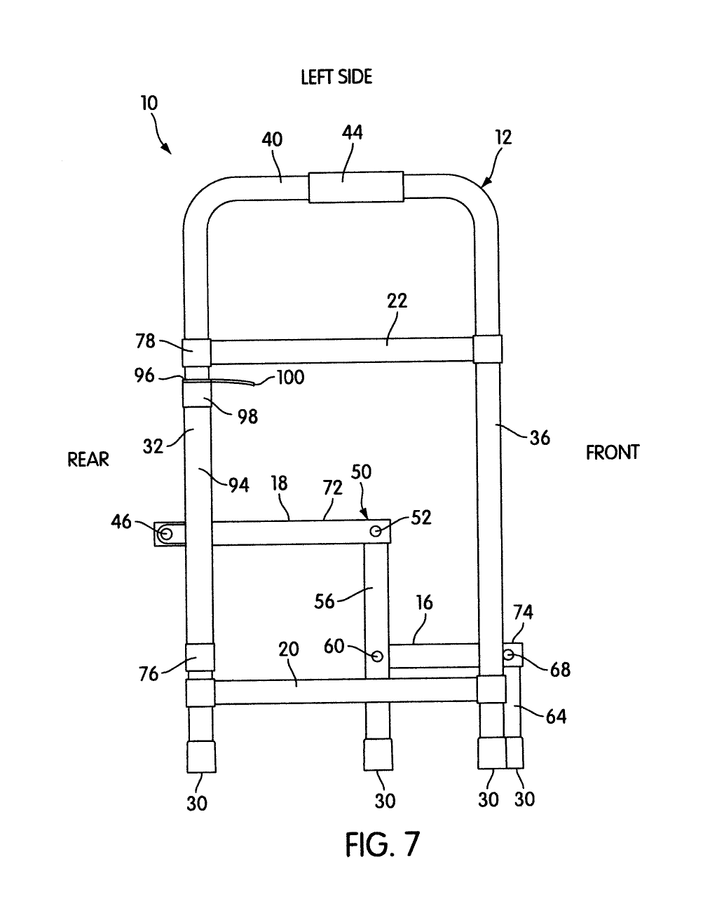

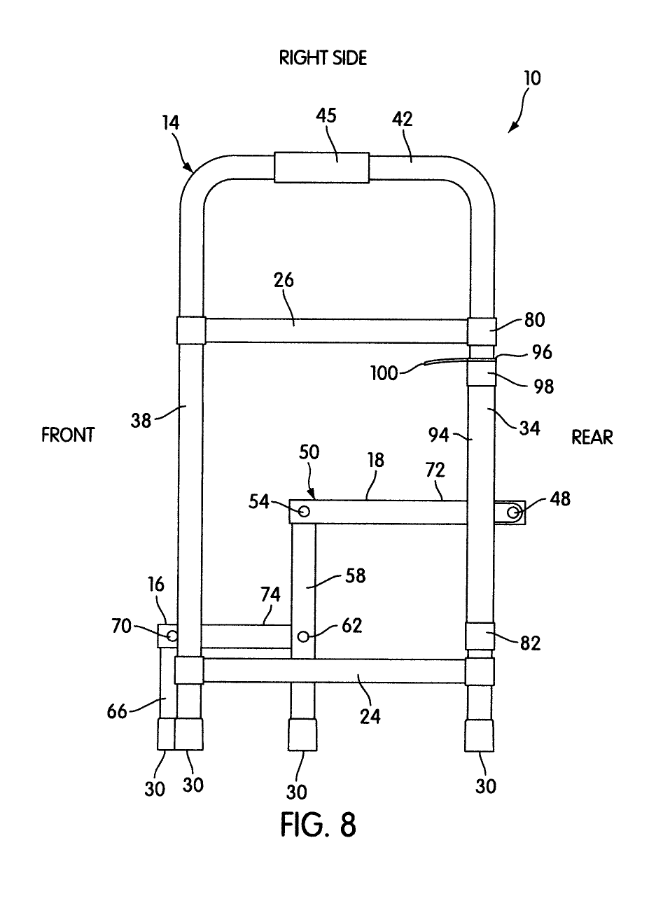

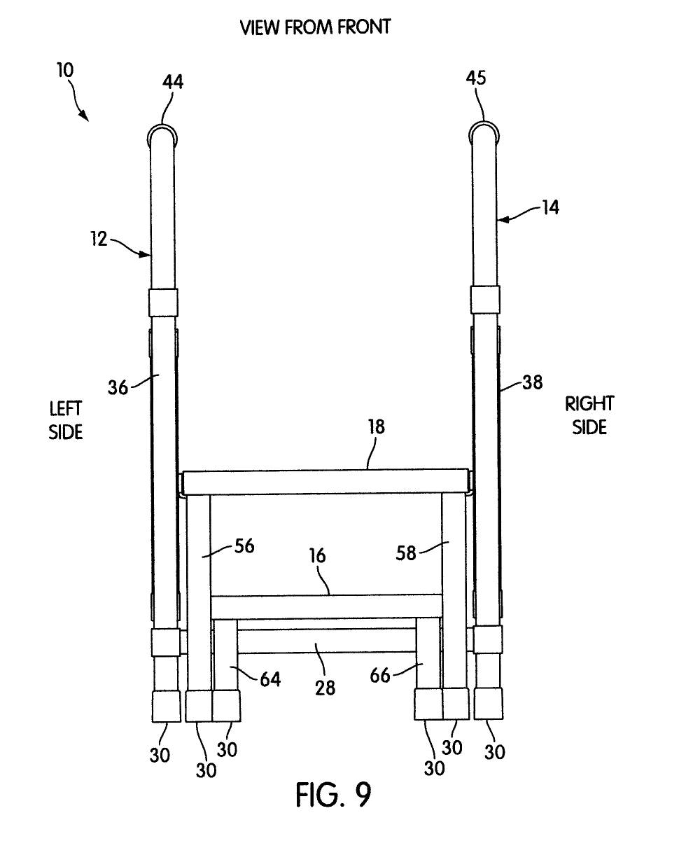

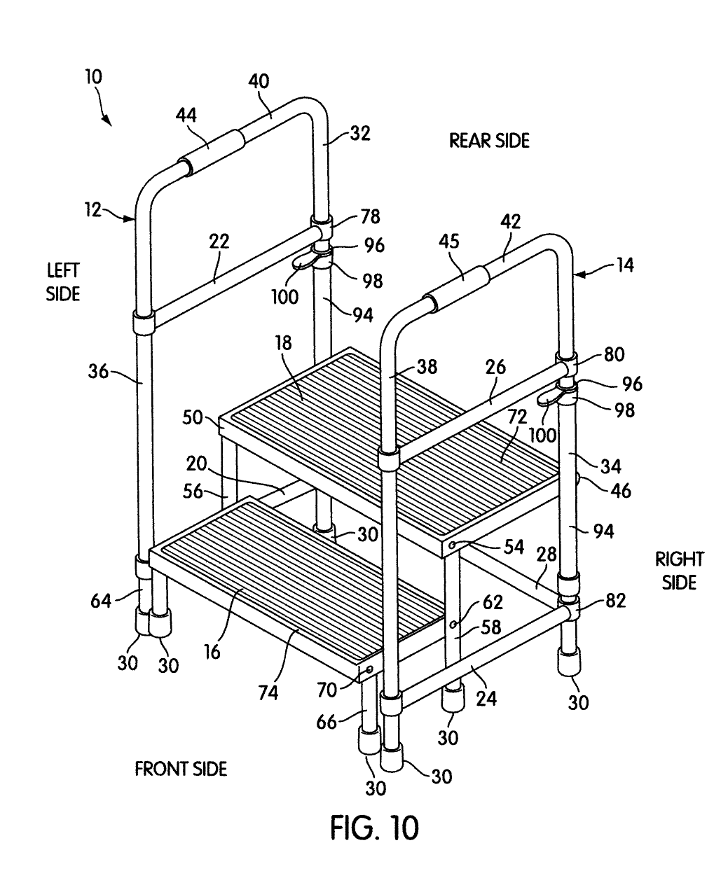

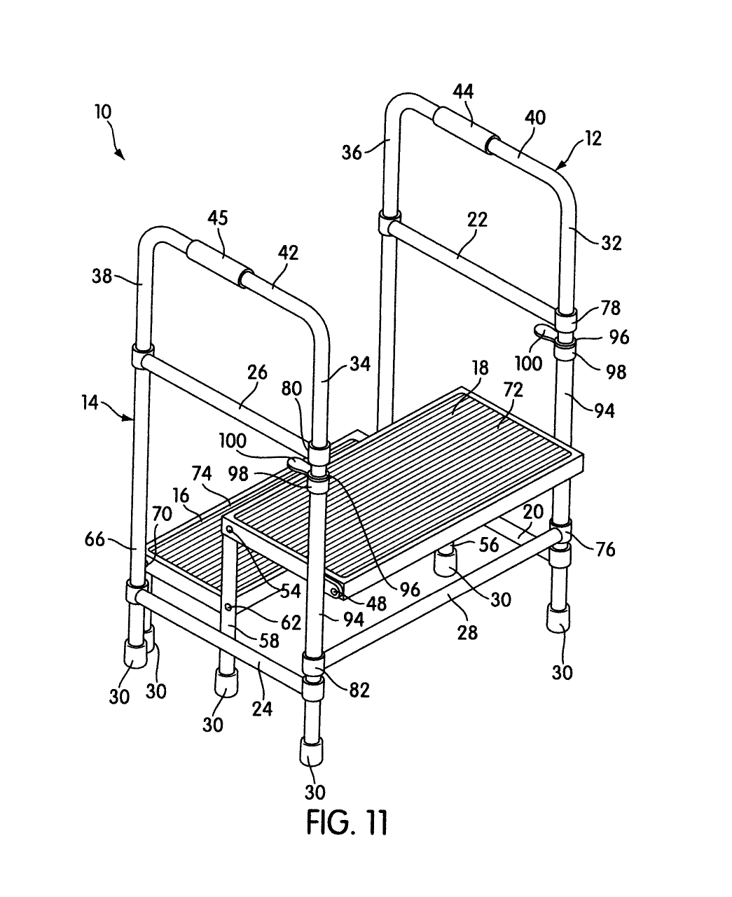

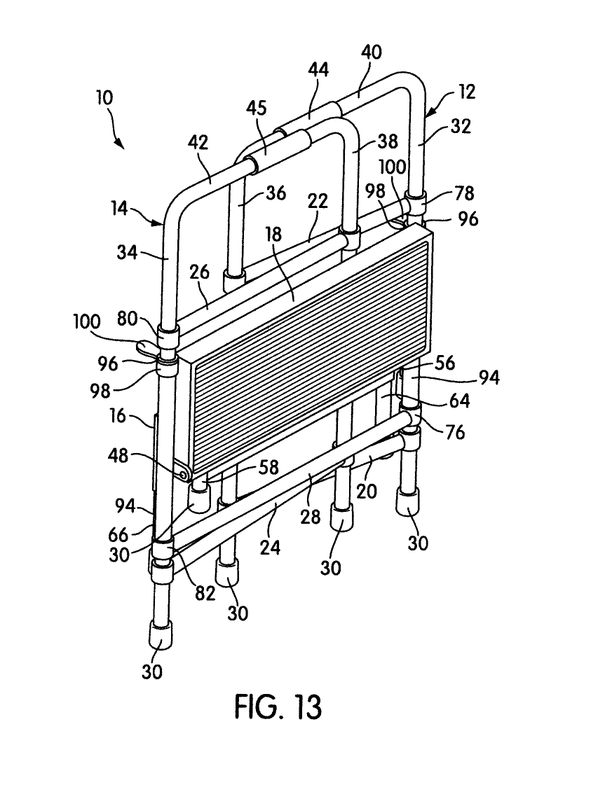

The first embodiment of the assistive device is a stepping device 10 illustrated in a first (left) side view in FIG. 7, a second (right) side view in FIG. 8 and a rear front view in FIG. 9. FIG. 10 illustrates an isometric front view of the assistive device and FIG. 11 illustrates an isometric rear view of the assistive device. FIG. 13 illustrates a closed position of the assistive device with the steps in an upwardly folded position and the sides folded inwardly.

The assistive device called Easy Step is comprised of opposing side frames 12 (left side) and 14 (right side) linked to one or more steps 16 and 18; and a plurality of support members 20, 22, 24, 26, and 28 and 35.

The assistive device of the present embodiment has a pair of foldable frames having generally U-shaped vertical side frames 12 (left side), 14 (right side) which are typically of a hollow tubular steel, aluminum or composite material construction. The side frames 12 (left side), 14 (right side) each include a rear leg 32 (left side) and 34 (right side) and a front leg 36 (left side), 38 (right side). These front and rear legs and the legs of the steps are each supported at the bottom by a friction device such as a rubber, plastic, cloth or felt cup 30. At the top of these vertical frames 12 (left side) and 14 (right side) each has an integral transverse horizontal support member 40 (left side) and 42 (right side) and are positioned to carry a hand grip 44 (left side) and 45 (right side) which the user may use to assist him or her in using the device. At approximately ⅔ of the height of these vertical frames 12 (left side) and 14 (right side) they have a second transverse horizontal support member 22 (left side) and 26 (right side). An additional integral transverse horizontal support member 20 (left side) and 24 (right side) is positioned near the bottom of each vertical side frame. There is a first cross support member 28 in a rear lower portion between the left frame 12 and the right frame 14. There is an option to add a second cross support member 35 higher in the device to provide further structural support. The rear of an upper step of a pair of vertically foldable steps 16 (lower step) and 18 (upper step) is coupled at its rear portion to the rear legs 32 (left side) and 34 right side) by a first pair of step folding mechanisms 46 (left side) and 48 (right side). The front of an upper step 50 is coupled to a first pair of step folding and locking mechanisms 52 (left side) and 54 (right side) provide a location for the foldable steps 16 and 18 to reside in their folded position. The front of the upper step 18 is coupled to a pair of upper step front legs 56 (left side) and 58 (right side) via the second pair of step folding and locking mechanisms 52 (left side) 54 (right side) that lock in the 90 degree position as illustrated in FIGS. 7 and 8.

The rear of a lower step 16 is coupled to the upper step front legs 56 (left side) and 58 (right side) via a second pair of step folding and locking mechanisms 60 (left side) 62 (right side). These second step folding mechanisms provide support for the rear of the lower step as well as support for the front of the upper step. The front of the lower step 16 is coupled to the lower step front legs 64 (left side) and 66 (right side) via a third pair of folding and locking 74 mechanisms 68 (left side) and 70 (right side). The upper and lower steps have a friction surface 72 (upper step) and 74 (lower step) to provide stability for the user. This may be made of rubber or a form of rubberized plastic. FIG. 13 illustrates Easy Step assistive device with its steps 16 and 18 folded upwardly and the side frames 12 and 14 folded inwardly. This folded configuration makes carrying and storing the device easier. The front legs of each side frame 12 and 14 are coupled hinged to the cross support member 28 at 76 and 82 for folding side frames 12 and 14 inwardly. This coupling includes a frame folding mechanisms that locks and holds the U-shaped frames into a 90 degree position when the assistive device is an unfolded state. Coupling mechanisms 78 (left side) and 80 (right side) couple horizontal members 22 and 26 to legs 32 and 34.

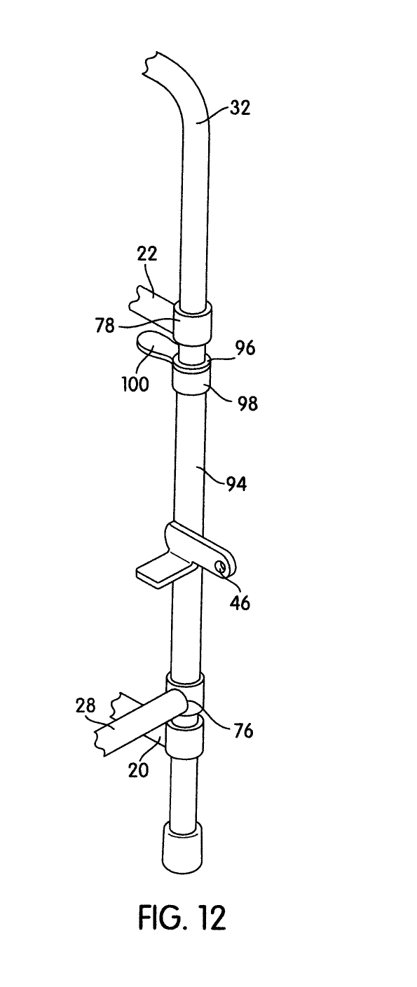

FIG. 12 illustrates a detailed discussion of the inwardly folding of left side rear leg 32. Right rear leg 34 folds inwardly in a similar fashion as a mirror image of FIG. 12. The rear leg 32 has transverse bushings 94 within the leg 32 below horizontal support member 22 at its coupling mechanism 78 and above horizontal cross member 28 at its coupling device 76. The rear leg 32 extends through and can rotate within the bushings to permit the left side frame 12 to be collapsed inwardly. Rear leg 32 also includes a locking mechanism 96 that comprises an annular catch plate 98 having a lock hole that is engaged by a spring biased detente. A handle 100 is used to disengage the lock. The folding frame system described in U.S. Pat. No. 7,040,637 ('637) describing a rollator is an example of such a folding frame system. The '637 patent is incorporated herein by reference. The folding step system described above is what makes the Easy Step Assistive Device from any rollator device.

FIG. 13 illustrates a closed position of the assistive device with the steps in a upwardly folded position and the sides folded inwardly.

Each rear leg each frame folding mechanism locks and holds one of the two U-shaped foldable frames into an approximately 90 degree position relative to the horizontal cross support when the assistive device is in said unfolded state. Each rear leg each frame folding mechanism unlocks and allows U of the two U-shaped foldable frames into an approximately folded parallel position relative to the horizontal cross support the said assistive is in a folded state.

In a preferred embodiment, the total height of the Easy Step assistive device is approximately 42 inches in height, 22 inches wide and 20 inches deep. The lower step 16 is approximately 5 inches from the floor with the upper step 18 being approximately 10 inches from the floor. The lower step 16 is approximately 18 inches wide and 10 inches deep. The upper step is approximately 20 inches wide and 15 deep. The depth of the upper step is designed to give the patient user space to turn around after stepping up to the upper step before placing himself or herself on the examination table. The horizontal support mechanisms containing the grips are approximately 42 inches from the ground, and 6 inches above the examination table or other horizontal patient support device. The total weight of the device is approximately 10 pounds and will support a patient/user weighing up to 400 pounds. As can be observed from FIGS. 7-11 and 13-18, legs 32, 34, 36 and 38 are of equal length. An optional feature is to make the height of the device adjustable by making the length of the legs 32, 34, 36 and 38 adjustable.

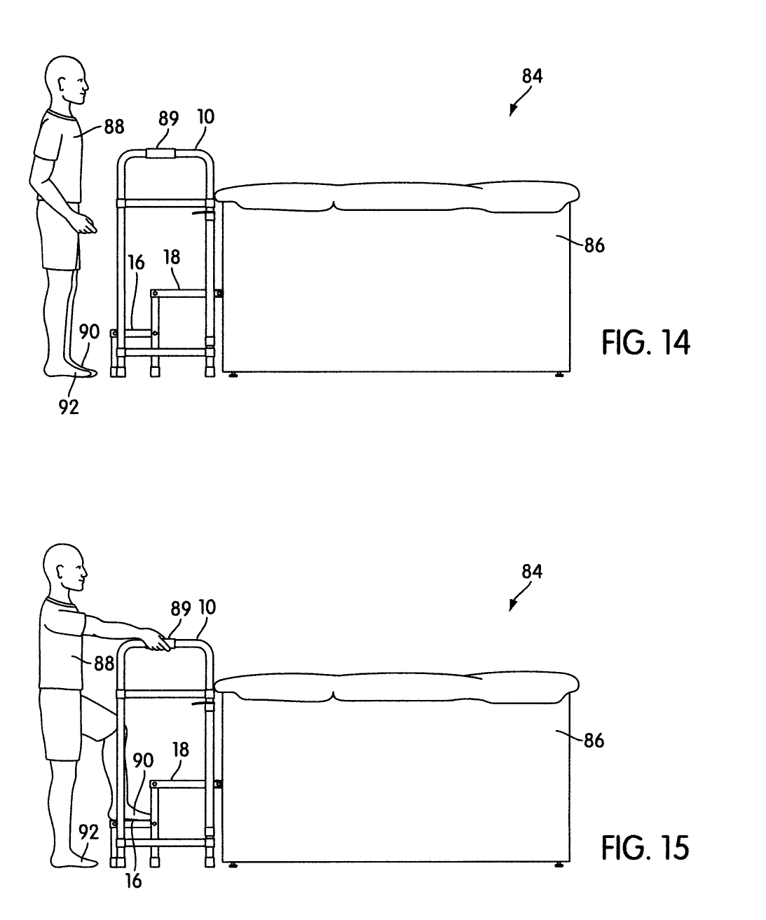

FIGS. 14-19 illustrate a patient's/user's 88 progression 84 from a beginning position in front of the assistive device 10 (in its open position) to the patient's/users sitting position on an examination table 86. FIG. 14 illustrates the user facing the device 10 that has been placed in front of a position on the examination table or bed 86 with the device's rear portion against the examination table or bed 86. The location of the device 10 with regard to the examination table 86 is up to the discretion of the physician or other care taker.

FIG. 15 illustrates a second portion of the progression of a patient/user 88 with his/her hands gripping the handles 89 and with a first foot 90 on the lower step 16 of the device 10. As illustrated, the first foot is a left foot, but may be the right foot 92.

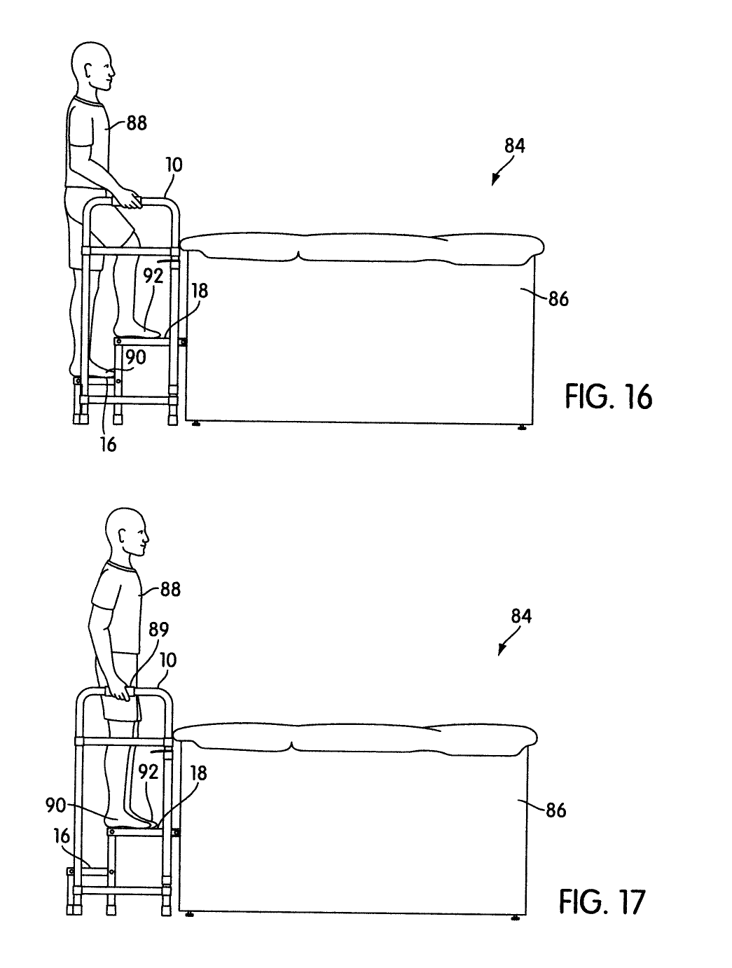

FIG. 16 illustrates the next portion of the progression of the patient/user 88 with his/her second foot 92 on the upper step 18 of the device 10 and the first foot 90 remaining on the lower step 16 of the device 10 while maintaining his/her hands on the grips 89 on the device 10. As illustrated, the first foot is a left foot and the second foot is a right foot, but it may be the reverse.

FIG. 17 illustrates the next portion of the progression of the patient/user 88 with both feet 90 and 92 on the upper step 18 and is in a standing position on the device 10 while gripping the grips 89.

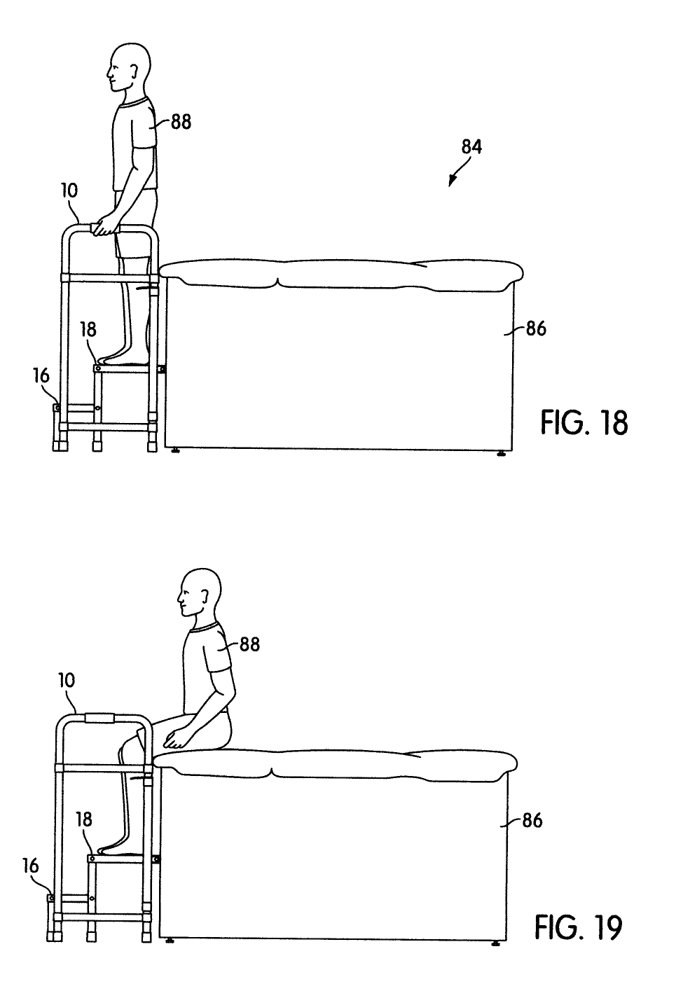

FIG. 18 illustrates the next of the progression of the patient/user 88 with the patient/user 88 having turned around on the upper step 18 to face away from the examination table 86 while still gripping the grips 89 on the device 10.

FIG. 19 illustrates the conclusion of the patient/user progression from a beginning position in front of the device 10 (in its open position) to the patient's/user's sitting position on the examination table 86.

Upon conclusion of his/her medical examination, the patient/user 88 reverses the progression to step down the device. In this case however, the patient may or may not turn around on the upper step as he/she may be more comfortable going down the step with his/her body facing away from the device 10 and examination table 86.

Prior to the progression described above, a caretaker or patient/user may unfold a folded device 10 and place the unfolded device in front of the examination table as illustrated in FIGS. 14-19. After use of the device 10 is completed a caretaker or patient/user may fold the device 10 as illustrated in FIG. 13.

### Second Embodiment

A second embodiment may include the addition of a wheel and brake system on the device so that it may be moved from one location to another without having to carry the device. More complicated embodiments are possible including those with wheels and/or an adjustable height for the user. If wheels are used, it may be necessary to have brakes to prevent the device from moving while in use. The wheel and brake system described in U.S. Pat. No. 7,040,637 ('637) describing a rollator is an example of such a wheel and brake system. The '637 patent is incorporated herein by reference.

### Third Embodiment

A third embodiment of the invention is an assistive device discussed in the first embodiments attached to or stored within a Siepman-Brewer ('084) device, a Smith-Midmark ('899) device, or a similar examination table with a pull out step system.

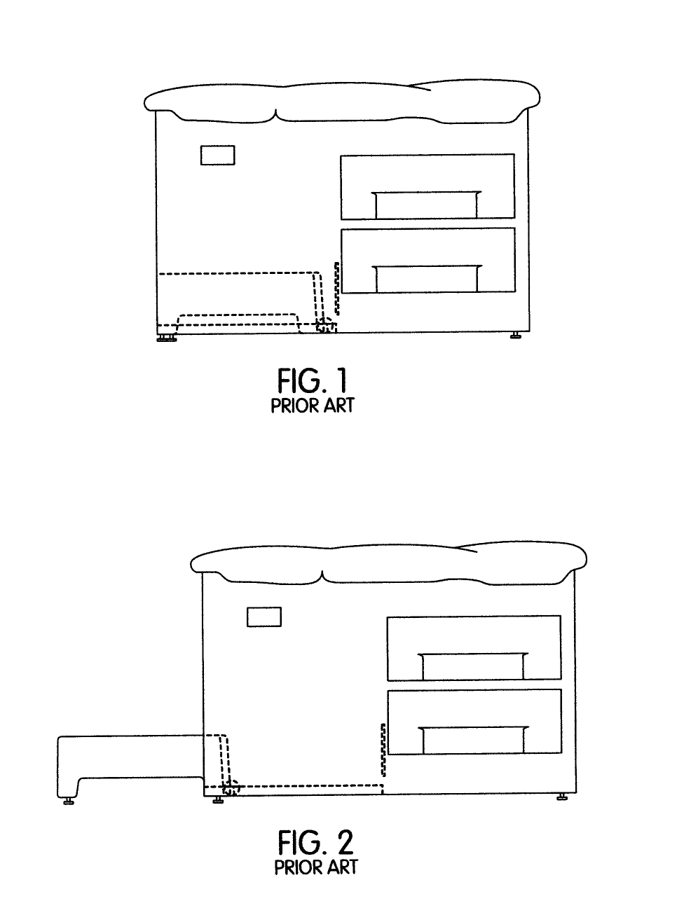

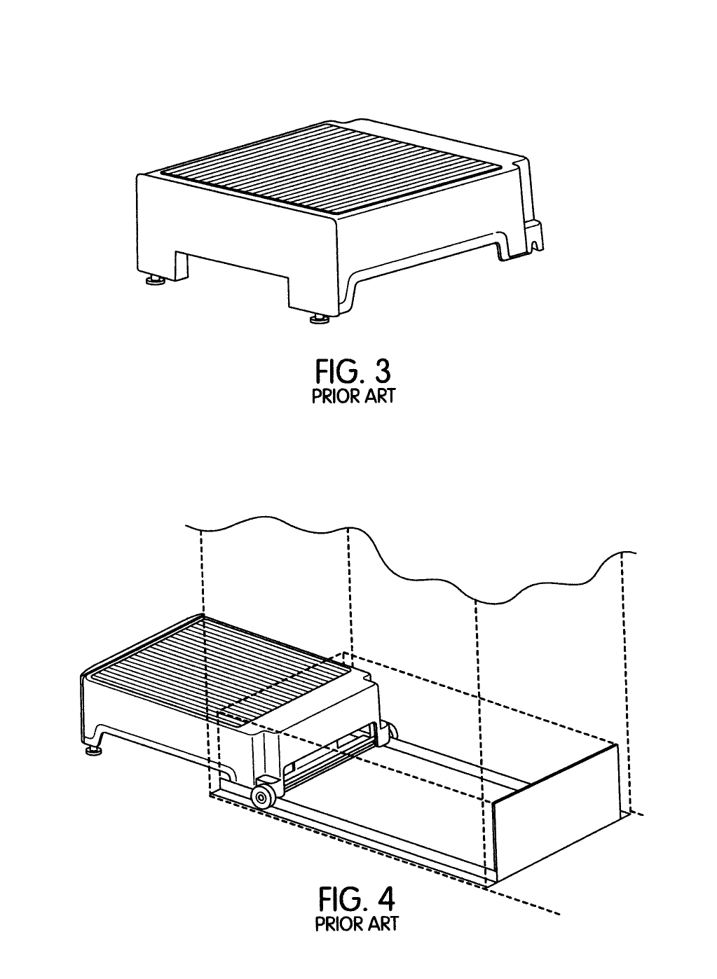

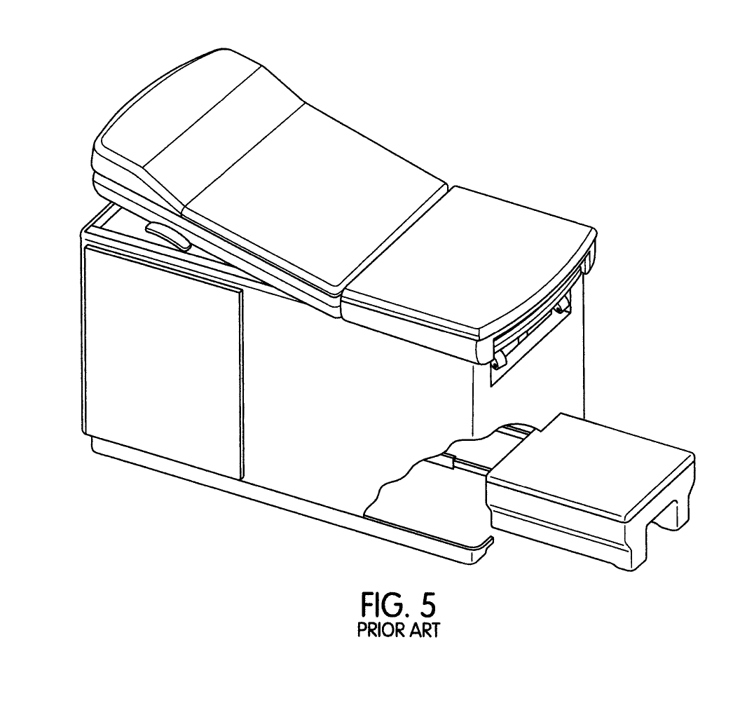

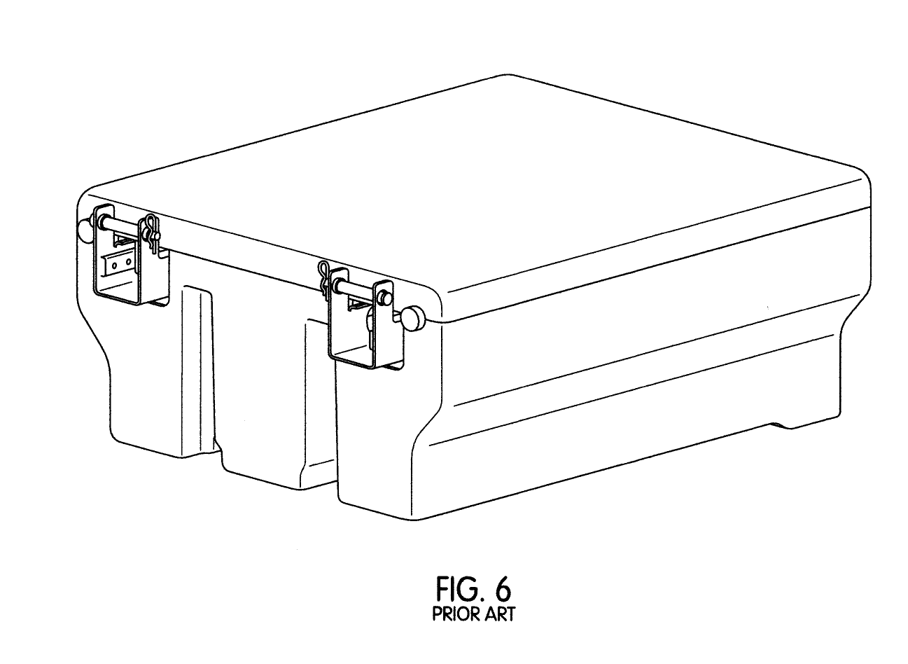

As was shown in FIGS. 1-6, the Siepman-Brewer ('084) and Smith-Midmark ('899) devices are medical examination tables with pull out drawers. The third embodiment of the invention is the attachment or storage of an assistive device as described in the first embodiment. This would be a non-wheel version as wheels are not needed when attached to the examination table. The storage may comprise folding the device as described above and rolling (if it has wheels) or carrying the folded device into the space previously used by the pull out step drawers in the Siepman-Brewer ('084) and Smith-Midmark ('899) medical examination tables with pull out drawers.

All the features disclosed in this specification (including any accompanying claims, abstract, and drawings) may be replaced by alternative features serving the same, equivalent or similar purpose, unless expressly stated otherwise. Thus, unless stated otherwise, each feature disclosed is one example only of generic series of equivalent or similar features. Additionally, all the US Patents referenced above are hereby incorporated herein by reference.

### DRAWING NUMBERS

10 ASSITIVE DEVICE
12 LEFT SIDE FRAME
14 RIGHT SIDE FRAME
16 LOWER STEP
18 UPPER STEP
20 LEFT SIDE LOWER SUPPORT MEMBER
22 LEFT SIDE UPPER SUPPORT MEMBER
24 RIGHT SIDE LOWER SUPPORT MEMBER
26 RIGHT SIDE UPPER SUPPORT MEMBER
28 REAR CROSS SUPPORT MEMBER
30 LEG SUPPORT CUP
32 LEFT SIDE REAR LEG
34 RIGHT SIDE REAR LEG
35 OPTIONAL REAR CROSS SUPPORT MEMBER
36 LEFT SIDE FRONT LEG
38 RIGHT SIDE FRONT LEG
40 LEFT SIDE TRANSVERSE HORIZONTAL SUPPORT MEMBER
42 RIGHT SIDE TRANSVERSE HORIZONTAL SUPPORT MEMBER
44 LEFT SIDE HAND GRIP
45 RIGHT SIDE HAND GRIP
46 LEFT SIDE UPPER STEP FOLDING MECHANISM—FIRST PAIR
48 RIGHT SIDE UPPER STEP FOLDING MECHANISM—SECOND PAIR
50 FRONT OF UPPER STEP
52 LEFT SIDE STEP FOLDING AND LOCKING MECHANISM SECOND PAIR
54 RIGHT SIDE STEP FOLDING ANDS LOCKING MECHANISM SECOND PAIR
56 LEFT SIDE UPPER STEP FRONT LEG
58 RIGHT SIDE UPPER STEP FRONT LEG
60 LEFT SIDE STEP FOLDING AND LOCKING MECHANISM THIRD PAIR
62 RIGHT SIDE STEP FOLDING ANDS LOCKING MECHANISM THIRD PAIR
64 LOWER STEP LEG LEFT SIDE
66 LOWER STEP LEG RIGHT SIDE
68 LEFT SIDE STEP FOLDING AND LOCKING MECHANISM FOURTH PAIR
70 RIGHT SIDE STEP FOLDING ANDS LOCKING MECHANISM FOURTH PAIR
72 FRICTION SURFACE UPPER STEP
74 FRICTION SURFACE LOWER STEP
76 LEFT SIDE FRAME FOLDING MECHANISM FOR SUPPORT BAR 28
78 COUPLING MECHANISM FOR SUPPORT BAR 22
80 COUPLING MECHANISM FOR SUPPORT BAR 26
82 RIGHT SIDE FRAME FOLDING MECHANISM FOR SUPPORT BAR 28
84 PATIENT USING DEVICE WITH AN EXAMINATION TABLE
86 EXAMINATION TABLE
88 PATIENT/USER
89 GRIPPING HANDLES
90 FIRST FOOT
92 SECOND FOOT
94 TRANSVERSE BUSHINGS
96 LOCKING MECHANISM
98 ANNULAR CATCH PLATE
100 LOCK HANDLE

I claim:

1. An assistive device for individuals with limited mobility comprising:
two U-shaped inwardly foldable side frames;
each respective U-shaped inwardly foldable side frame has a plurality of horizontal frame support members within each respective side frame;
at least one non-folding horizontal cross support member coupled to and between a rear portion of each inwardly foldable U-shaped frame; and
a plurality of steps coupled to said frames by a plurality of upwardly folding mechanisms,
wherein said assistive device is in an unfolded state when adjacent to a generally horizontal patient support apparatus and
wherein said assistive device and said adjacent patient support apparatus are floor or ground supported.

2. The assistive device of claim 1 further comprising:
each U-shaped inwardly foldable frames includes a front frame leg and a rear frame leg.

3. The assistive device of claim 2 further comprising:
a first horizontal frame support member of said plurality of horizontal frame support members at an upper end of each U-shaped inwardly foldable side frames and is positioned to carry a hand grip.

4. The assistive device of claim 3 further comprising:
a second horizontal support member of said plurality of horizontal frame support members at approximately ⅔ of a height of each U-shaped horizontally foldable side frame.

5. The assistive device of claim 4 further comprising:
a third horizontal frame support member of said plurality of horizontal frame support members at a lower location between said front leg and said rear leg of each U-shaped inwardly foldable side frame.

6. The assistive device of claim 5 further comprising:
each said one or more horizontal cross support members is coupled between said rear legs of each U-shaped inwardly foldable side frames.

7. The assistive device of claim 6 further comprising;
said at least one horizontal cross support member coupled to each rear leg of each U-shaped inwardly foldable frames coupled by a frame folding mechanism that locks and holds each U-shaped inwardly foldable frame into an approximately 90 degree position relative to said at least one horizontal cross support when said assistive is in said unfolded state.

8. The assistive device of claim 6 further comprising:
each foldable step of said a plurality of foldable steps hingedly coupled to a respective rear leg of each U-shaped inwardly foldable side frames.

9. The assistive device of claim 8 further comprising:
an upper foldable step of said plurality of foldable steps hingedly coupled to a respective rear leg of respective rear frame by a first pair of frame folding mechanisms.

10. The assistive device of claim 9 further comprising:
a pair of step folding mechanisms for said foldable steps to be moved into an upwardly folded position when said assistive device is in a folded state.

11. The assistive device of claim 10 further comprises:
a front of said upper steps coupled to a pair of upper step front legs by a second pair of step folding mechanisms that hold a lower step in a horizontal position.

12. The assistive device of claim 11 further comprising:
a rear portion of a lower step is coupled to said pair of upper step front legs by a third pair of step folding mechanisms that hold said upper step front legs in a 90 degree position.

13. The assistive device of claim 12 further comprising:
a front of said lower step is coupled to a pair of lower step front legs by a fourth pair of step folding mechanisms that hold said lower step in a horizontal position.

14. The assistive device of claim 13 wherein when said assistive device is in a folded state with said folding steps folded upwardly and said side frames are folded inwardly for storage of said assistive device.

15. The assistive device of claim 14 wherein said assistive device support members are made of aluminum, steel or composite materials.

16. The assistive device of claim 15 wherein said each of said steps has a non-slip surface on a stepping surface to provide a safe support for a patient/user.

17. The assistive device of claim 16 wherein said non-slip surface is composed of rubber or rubberized plastic.

18. The assistive device of claim 17 wherein each said frame leg and has a friction cup.

19. The assistive device of claim 18 wherein each said friction cup is made of rubber, rubberized plastic, cloth or felt.

20. The assistive device of claim 15 wherein said assistive device is approximately 42 inches in height, 22 inches wide and 20 inches deep with said lower step being approximately 5 inches from the floor, with said upper step being approximately 10 inches from the floor;
further wherein said lower step is approximately 18 inches wide and 10 inches deep and said upper step is approximately 20 inches wide and 15 inches deep; and
further wherein said grips are approximately 38 inches from said floor or ground and 6 inches above said generally horizontal patient support device.

21. An assistive device for enabling individuals comprising:
a pair of U-shaped inwardly foldable frames;
each U-shaped foldable frame has a front leg and a rear leg;
each U-shaped foldable frame has a first horizontal support member at its top and is positioned to carry a hand grip;
each U-shaped foldable frame has a second horizontal frame support member at approximately ⅔ of a height of each frame;
each U-shaped foldable frame has a third horizontal frame support member at a lower location;
each U-shaped foldable frame coupled to each end of at least one horizontal support member located at a rear of said assistive device;
each U-shaped foldable frame coupled to said at least one horizontal frame support member using a frame folding mechanism that locks into a 90 degree position;
said assistive device further comprises a pair of upwardly foldable steps that are hingedly coupled to said rear legs of said U-shaped inwardly foldable frames;
a rear of an upper step of said pair of foldable steps hingedly coupled to said rear frame legs by a first pair of frame folding mechanisms;
a front of said upper step is coupled to said a first pair of step folding mechanisms and provides a location for said foldable steps to reside in their a folded position;
a front of said upper step is coupled to a pair of upper step front legs by a second pair of folding mechanisms that holds said upper step front legs in a 90 degree position;
a rear of a lower step is coupled to said pair of upper step front legs by a third pair of folding mechanisms that lock and hold said legs in a 90 degree position; and
a front of said lower step is coupled to a pair of lower step front legs by a fourth pair of folding and locking mechanisms that locks and holds said legs in a 90 degree position;
wherein each frame folding mechanism within each frame rear leg comprising:
transverse bushings within a mid-portion, below said second horizontal frame support member and above said third frame support member;
a locking mechanism having an annular catch plate with a lock hole that is engaged by a spring biased détente; and
a handle to disengage said locking mechanism;
wherein each rear leg each frame folding mechanism locks and holds one of said two U-shaped foldable frames into an approximately 90 degree position relative to said at least one horizontal cross support when said assistive is in said unfolded state and further wherein each rear leg each frame folding mechanism unlocks and allows holds one of said two U-shaped foldable frames into an approximately folded parallel position relative to said at least one horizontal cross support when said assistive is in a folded state.
wherein said assistive device is in an unfolded state when adjacent to said generally horizontal patient apparatus and
further wherein said assistive device and adjacent patient support apparatus are floor or ground supported.

23. The assistive device of claim 22 wherein when said assistive device is in a folded state said folding steps are folded upwardly and the side frames are folded inwardly for storage of said assistive device.

24. A method of a patient/user using the device described in claim 1 comprising the acts of:
unfolding a folded device (if folded);
placing said device with a rear portion facing and against an examination table or bed;
gripping a pair of grips and placing a first foot on a lower step;
placing a second foot on an upper step with said first foot remaining on said lower step;
maintaining his/her hands on said grips;
placing said second foot on said second step, thus having both feet on said upper step and in a standing position while gripping said grips;
turning around on said upper step to face away from said examination table or bed while still gripping the grips, and
moving to a sitting position on said examination table.

26. The method of claim 25 wherein said first foot is a left foot and said second foot is a right foot.

27. The method of claim 25 wherein said first foot is a right foot and said second foot is a left foot.

28. The method of claim 25 wherein said patient user reverses the process of claim 25 to step down from the generally horizontal patient device, however, said patient may choose to not turn around on said upper step, thus remaining facing away from generally horizontal patient support device through the whole process.

29. The assistive device of claim 2 wherein each frame front leg and each frame rear frame leg are of equal length.

30. The assistive device of claim 22 wherein each frame front leg and each rear frame leg are of equal length.

31. The assistive device of claim 7 wherein each frame folding mechanism within each frame rear leg further comprises:
transverse bushings within a mid-portion, below said second horizontal frame support member and above said third frame support member;
a locking mechanism having an annular catch plate with a lock hole that is engaged by a spring biased détente; and
a handle to disengage said locking mechanism;
wherein each rear leg each frame folding mechanism locks and holds one of said two U-shaped foldable frames into an approximately 90 degree position relative to said at least one horizontal cross support when said assistive is in said unfolded state and further wherein each rear leg each frame folding mechanism unlocks and allows holds one of said two U-shaped foldable frames into an approximately folded parallel position relative to said at least one horizontal cross support when said assistive is in a folded state.
